(19) United States
(12) Patent Application Publication
(10) Pub. No.: US 2023/0171834 A1
(43) Pub. Date: Jun. 1, 2023

(54) RADIO COMMUNICATION APPARATUS AND RADIO COMMUNICATION METHOD

(71) Applicant: Panasonic Intellectual Property Management Co, Ltd., Osaka (JP)

(72) Inventors: Kosei NAKANO, Kanagawa (JP); Hiroyuki MOTOZUKA, Kanagawa (JP); Takenori SAKAMOTO, Kanagawa (JP); Akihiro EGAMI, Tokyo (JP); Masataka IRIE, Kanagawa (JP); Yao Huang Gaius WEE, Singapore (SG)

(21) Appl. No.: 18/159,578

(22) Filed: Jan. 25, 2023

Related U.S. Application Data
(63) Continuation of application No. PCT/JP2021/027617, filed on Jul. 27, 2021.

(30) Foreign Application Priority Data
Jul. 28, 2020 (JP) 2020127570

(51) Int. Cl. H04W 76/18

(52) U.S. Cl. CPC H04W 76/18

(57) ABSTRACT

A radio communication apparatus includes: processing circuitry, which, in operation, scans a radio connection destination candidate; and control circuitry, which, in operation, determines, when first initial-connection processing to the connection destination target fails, a start timing of second-initial connection processing based on a cause of the failure. The processing circuitry scans the connection destination candidate based on the start timing of the second initial-connection processing.

### CROSS REFERENCE TO RELATED APPLICATIONS

This application is entitled to (or claims) the benefit of Japanese Patent Application No. 2020-127570, filed on Jul. 28, 2020, the disclosure of which including the specification, drawings and abstract is incorporated herein by reference in its entirety.

### TECHNICAL FIELD

The present disclosure relates to a radio communication apparatus and a radio communication method.

### BACKGROUND ART

Patent Literature (hereinafter, referred to as PTL) 1 discloses a radio connection via a radio Local Area Network (LAN) using IEEE 802.11ai as a means of Vehicle to X (V2X) communication (e.g., Vehicle to Vehicle (V2V) communication).

### CITATION LIST

### Patent Literature

PTL 1 Japanese Patent Application Laid-Open No. 2014-96630

### Non Patent Literature

NPL 1 IEEE 802.11-2016

### SUMMARY OF INVENTION

### Technical Problem

For example, there is scope for further study on speeding up a radio connection between two radio communication apparatuses (e.g., a radio base station and a terminal).

One non-limiting and exemplary embodiment of the present disclosure facilitates providing a radio communication apparatus and a radio communication method that each realize a high-speed radio connection between radio communication apparatuses.

### Solution to Problem

A radio communication apparatus according to an embodiment of the present disclosure includes: processing circuitry, which, in operation, scans a radio connection destination candidate; and control circuitry, which, in operation, determines, when first initial-connection processing to the connection destination target fails, a start timing of second-initial connection processing based on a cause of the failure, wherein the processing circuitry scans the connection destination candidate based on the start timing of the second initial-connection processing.

It should be noted that a general or specific embodiment may be implemented as a system, an apparatus, a method, an integrated circuit, a computer program, a storage medium, or any selective combination thereof.

### Advantageous Effects of Invention

According to an embodiment of the present disclosure, it is possible to shorten (speed up) an initial-connection time by radio in roadside-unit-to-moving-object communication or moving-object-to-moving-object communication, and a connection success rate can be enhanced.

Additional benefits and advantages of one embodiment of the present disclosure will become apparent from the specification and drawings. The benefits and/or advantages may be individually obtained by some embodiments and features described in the specification and drawings, which need not all be provided in order to obtain one or more of such features.

### BRIEF DESCRIPTION OF DRAWINGS

FIG. 1 illustrates an entire road-to-vehicle system according to an embodiment of the present disclosure;

FIG. 2 is a block diagram illustrating an exemplary configuration of an onboard unit and a roadside unit according to the embodiment of the present disclosure;

FIG. 3 illustrates an exemplary functional block in a CPU of the onboard unit according to the embodiment of the present disclosure;

FIG. 4 is a flowchart illustrating an exemplary operation of the onboard unit according to the embodiment of the present disclosure;

FIG. 5 is a flowchart illustrating an exemplary operation of the onboard unit according to Variation 1 of the embodiment of the present disclosure;

FIG. 6 illustrates an exemplary functional block in a CPU of the onboard unit according to Variation 2 of the embodiment of the present disclosure; and

FIG. 7 is a flowchart illustrating an exemplary operation of the onboard vehicle according to Variation 2 of the embodiment.

### DESCRIPTION OF EMBODIMENTS

In a case where a radio communication in which the communication area is limited, such as a communication using a 60 GHz millimeter wave, is applied to V2X communication, it is assumed that a travelling vehicle enters a communication area of a cell (e.g., a radio base station apparatus) from a cell edge where the communication environment is poor (e.g., an edge of a communication area of a radio base station apparatus). Thus, a packet error is likely to occur in the initial-connection phase between a cell (e.g., a radio base station apparatus) and the vehicle (e.g., a terminal device). Due to a failure of a packet exchange between the cell and the vehicle resulting from an increase in packet errors in the initial-connection phase, normal initial-connection processing may not be performed, and a connection delay may occur. Alternatively, due to the failure of a packet exchange between the cell and the vehicle, the vehicle may pass the communication area of the cell without successfully connecting with the cell even once. Alternatively, even when the vehicle can connect with the cell, the communication time remaining for the vehicle to perform communication while in the communication area of the cell is reduced, and thus it is difficult to perform large-capacity data communication.

In the present embodiment, a high-speed radio connection between radio communication apparatuses is enabled by suppressing an increase in connection delays in the initial-connection caused by a packet exchange failure.

Hereinafter, an embodiment of the present disclosure will be described with reference to the drawings.

### Embodiment

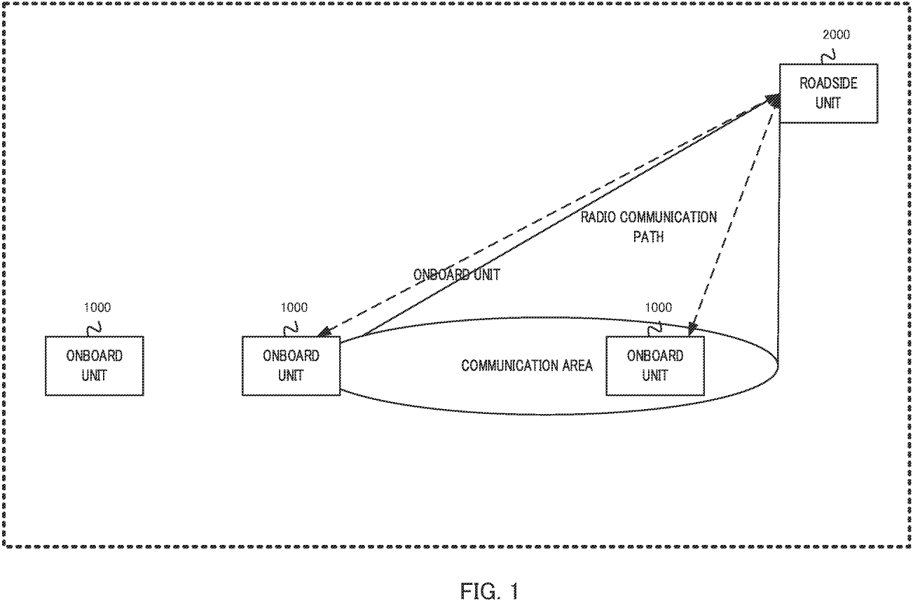

FIG. 1 illustrates an entire road-to-vehicle (infrastructure to vehicle (I2V)) system according to an embodiment of the present disclosure.

As an example, FIG. 1 illustrates an environment in which onboard units 1000 mounted on vehicles and roadside unit 2000 are present. Onboard units 1000 are each mounted on a vehicle present at an intersection, on an arterial road, on a highway, or the like. Note that FIG. 1 illustrates one roadside unit 2000, but a plurality of roadside units 2000 may be present. Further, FIG. 1 illustrates three onboard units 1000, but the number of onboard units 1000 is not limited to three.

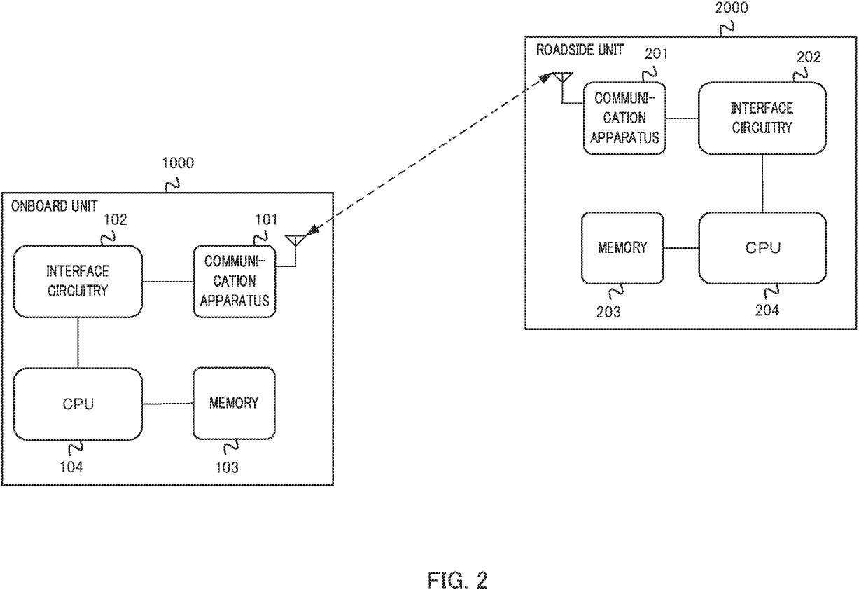

Onboard unit 1000 is attached to a vehicle. Onboard unit 1000 includes, for example, communication apparatus 101 (see FIG. 2). Roadside unit 2000 is installed in a traffic light, a street light, a utility pole, and/or the like. Roadside unit 2000 includes, for example, communication apparatus 201 (see FIG. 2). Communication apparatus 101 of onboard unit 1000 is connected by radio to communication apparatus 201 in the communication area of communication apparatus 201 of roadside unit 2000, and transmits and receives data, for example.

FIG. 2 is a block diagram illustrating an exemplary configuration of onboard unit 1000 and roadside unit 2000 according to the embodiment.

Onboard unit 1000 includes communication apparatus 101, interface (IF) circuitry 102, memory 103, and central processing unit (CPU) 104. Communication apparatus 101 is controlled by CPU 104 via IF circuitry 102, and performs signal transmission processing and signal reception processing.

Communication apparatus 101 need not be incorporated into onboard unit 1000. For example, communication apparatus 101 may be attached externally as long as communication apparatus 101 is connectable to interface circuitry 102 via Universal Serial Bus (USB), for example.

Roadside unit 2000 includes communication apparatus 201, IF circuitry 202, memory 203, and CPU 204. Communication apparatus 201 is controlled by CPU 204 via IF circuitry 202, and performs signal transmission processing and signal reception processing.

Communication apparatus 201 need not be incorporated into roadside unit 2000. For example, communication apparatus 201 may be attached externally as long as communication apparatus 201 is connectable to interface circuitry 202 via Universal Serial Bus (USB), for example.

In the following description, an example will be described in which communication apparatus 101 and communication apparatus 201 communicate with each other using an infrastructure mode.

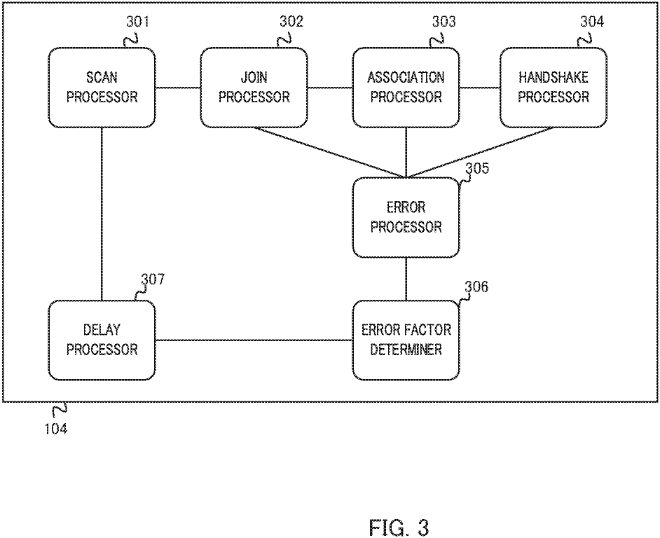

FIG. 3 illustrates an exemplary functional block in CPU 104 of onboard unit 1000 according to the embodiment. CPU 104 includes scan processor 301, join processor 302, association processor 303, handshake processor 304, error processor 305, error factor determiner 306, and delay processor 307. A process of each component will be described along with an operation example of onboard unit 1000 to be described below.

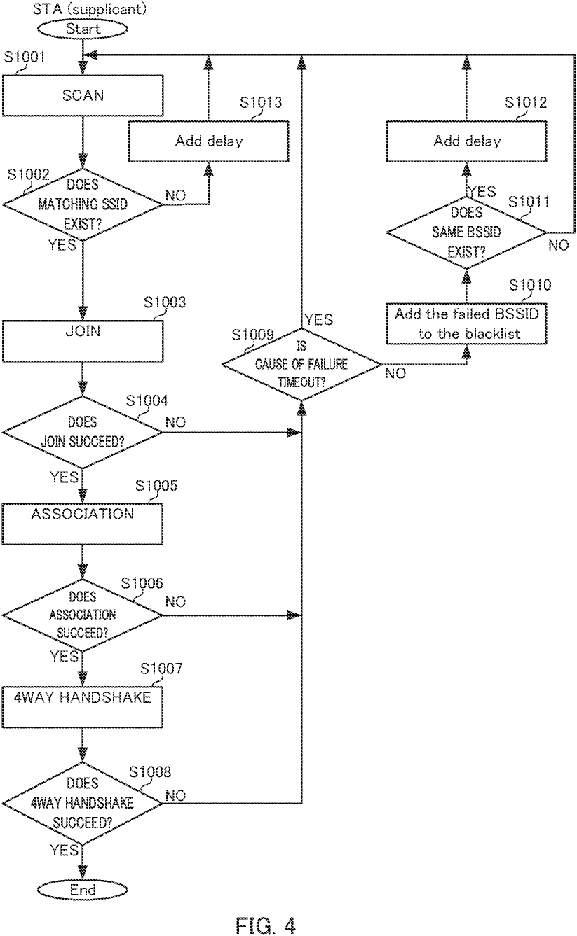

FIG. 4 is a flowchart illustrating an exemplary operation of onboard unit 1000 according to the embodiment. FIG. 4 illustrates a procedure of initial-connection processing by a supplicant that performs an authorization procedure in accordance with an Active Scan and an Association of IEEE 802.11ad and/or IEEE 802.11ay, which are 60 GHz millimeter-wave communication standards.

Note that, in the following description, onboard unit 1000 may be referred to as a terminal (or a station (STA)). Further, roadside unit 2000 may be referred to as a radio base station (or an access point (AP)). In the embodiment, exemplarily, a terminal corresponds to onboard unit 1000 and a radio base station corresponds to roadside unit 2000, but the present disclosure is not limited thereto. For example, a terminal is not limited to an onboard unit, and may be applied to a unit different from the onboard unit. Further, a radio base station is not limited to a roadside unit, and may be applied to a unit different from the roadside unit.

Note that the radio base station may be an AP or a PCP (hereinafter, represented as “AP/PCP”). Further, in this case, a radio communication apparatus of non-AP/PCP may be an STA (or a child device or a terminal).

Further, a description of a procedure of an authenticator authenticating the supplicant is omitted.

In S1001, scan processor 301 performs scan (SCAN) processing. For example, in the scan processing, scan processor 301 first performs an Active Scan and searches for a communicable AP, which is a connection destination candidate. In the Active Scan, procedures of Beacon Transmission Interval (BTI) processing, processing during Association-Beamforming Training (A-BFT), and Probe exchange processing are performed.

For example, scan processor 301 receives a Directional Multi-Gigabit (DMG) beacon from an AP and completes a Probe exchange. The STA continues to search for an AP until the scan time expires (times out) because another communicable AP may be present even when a Probe exchange with a certain communicable AP is completed. Scan processor 301 performs an Active Scan on each frequency (channel). When finishing scanning at each channel, the flow shifts to the process of S1002.

Note that scan processor 301 may shorten the time until the flow shifts from S1001 to S1002 in a case where a Probe exchange is completed even though the scanning time is shortened. Further, scan processor 301 may shorten the time of scan processing in S1001 by limiting the channels subject to scanning in S1001 to reduce the number of channels subject to scanning. For example, the channels subject to scanning are limited to channels allocated exclusively for Intelligent Transport Systems (ITS), and thus the time of scan processing may be shortened. Accordingly, the time until the flow shifts to S1002 can be shortened, and the Active Scan processing can be speeded up. Further, the frequency utilization efficiency can be enhanced.

In S1002, scan processor 301 determines whether a list of the scanning result performed in S1001 includes a Service Set Identifier (SSID) matching with the connection destination candidate (e.g., AP).

When the matching SSID is included (Yes in S1002), the flow shifts to S1003. At this time, the SSID is an identifier for identifying an AP, and the information on the SSID corresponding to the connection destination candidate (e.g., AP) may be included in scan processor 301 in advance. Note that the information on the connection destination candidate (e.g., AP) may be recorded in the connection history that the STA owns, or the vehicle on which the STA is mounted may be a pre-approved vehicle and the information may be registered in advance. Alternatively, the STA may obtain information on an AP in the vicinity of the STA from Global Positioning System (GPS) position information or navigation information, may obtain information on an AP from another communication path such as Long Term Evolution (LTE) and/or Dedicated Short Range Communications (DSRC), or may obtain information on an AP from the Internet.

Note that, when a plurality of matching SSIDs are present, scan processor 301 may receive the signals from the APs corresponding to the plurality of the matching SSIDs, respectively, compare the quality of the reception signals, and determine that the AP of a transmission source of the reception signal having the best quality is the candidate for the communication counterpart or determine that the AP whose connection time can be judged to be the longest is the candidate for the communication counterpart. Note that an example of the “quality (reception signal quality)” includes Signal Noise Ratio (SNR) and Received Signal Strength Indication or Received Signal Strength Indicator (RSSI).

On the other hand, when no matching SSID is present or a Probe exchange fails (NO in S1002), the flow shifts to S1013.

In S1003, join processor 302 performs Join processing. For example, in the Join processing, join processor 302 receives a DMG beacon again from the AP determined in S1002, and sets a timer (e.g., Join Failure Timer) waiting for Join completion to perform synchronization with the AP. For example, to the timer waiting for Join completion, a time obtained by adding a predetermined synchronization time to an integral multiple of the beacon interval (BI) may be set. Then, the flow shifts to S1004.

In S1004, error processor 305 receives a DMG beacon again, completes the synchronization with the AP, and determines whether the Join succeeds. When the Join succeeds (YES in S1004), the flow shifts to S1005. On the other hand, when the Join does not succeed (fails) (NO in S1004), the flow shifts to S1009.

For example, the case where the Join fails includes a case where the timer waiting for Join completion times out and a case where it is determined that the Join fails before the timer waiting for Join completion times out. The case where the timer waiting for Join completion times out is, for example, a case where the communication environment deteriorates, a case where the communication is interrupted by the vehicle that travels in the vicinity interrupting the space between the AP and the STA, and a case where the DMG beacon cannot be received because of being outside the communication area.

In S1005, association processor 303 performs Association processing. For example, association processor 303 sets a timer waiting for Association completion (e.g., an Authentication Timer) and executes an Association exchange. For example, the timer waiting for Association completion may be set to about a period of time (e.g., several tens of milliseconds) in which BFT and an Association exchange are completed. Then, the flow shifts to S1006.

In S1006, error processor 305 determines whether the Association exchange is completed (succeeds). When the Association exchange is completed (succeeds) and the access permission from the AP is obtained (YES in S1006), the flow shifts to S1007. On the other hand, when the Association exchange fails (NO in S1006), the flow shifts to S1009.

For example, the case where the Association exchange fails may be a case where the timer waiting for Association completion times out and/or a case where it is determined that the Association fails before the timer waiting for Association completion times out. The case where the timer waiting for Associate completion times out may be, for example, a case where the communication environment deteriorates, a case where the communication is interrupted by the vehicle that travels in the vicinity interrupting the space between the AP and the STA, and/or a case where a packet reception error continuously occurs because of being outside the communication area. Further, the case where it is determined that the Association fails before the timer waiting for Associate completion times out may be a case where the connection is rejected by an AP because the password setting or the like is different (e.g., referred to as “Association reject”), or a case where the connection is rejected by an AP due to an unauthorized access from a third party.

In S1007, handshake processor 304 performs key generation processing (e.g., 4-way handshake (may be referred to as 4WAY HANDSHAKE)) to perform encrypted data communication. For example, handshake processor 304 sets a timer (e.g., an Authentication Timer) waiting for completion of key generation processing (4-Way Handshake) to perform encrypted data communication. For example, the timer waiting for completion of key generation processing (4-Way Handshake) may be set to about several tens of milliseconds. Then, the flow shifts to S1008.

In S1008, error processor 305 determines whether the 4-Way Handshake is completed (succeeds). When the 4-Way Handshake is completed (succeeds) (YES in S1008), the AP and the STA are in a state of connecting with each other, and the flow illustrated in FIG. 4 ends. Thereafter, encrypted data communication by radio connection (layer 2) can be performed. In practice, a negotiation on equal to or higher than layer 3 (DHCP, DNS, or TLS/SSL) is started to perform data communication. Meanwhile, when the 4-Way Handshake fails (NO in S1008), the flow shifts to S1009.

For example, the case where the 4-Way Handshake fails may be a case where the timer waiting for completion of key generation processing times out, and/or a case where it is determined that the timer waiting for completion of key generation processing fails before the timer waiting for completion of key generation processing times out. The case where the timer waiting for completion of key generation processing times out may be, for example, a case where the communication environment deteriorates in the 4-Way Handshake, a case where the communication is interrupted by the vehicle that travels in the vicinity interrupting the space between the AP and the STA, and/or a case where a packet reception error continuously occurs because of being outside the communication area. Further, the case where it is determined that the timer waiting for completion of key generation processing fails before the timer waiting for completion of key generation processing times out may be, for example, a case where the connection is rejected by an AP because the password setting or the like is different (e.g., referred to as “Association reject”), or a case where the connection is rejected by an AP because of an unauthorized access from a third party.

In S1009, error factor determiner 306 determines whether the cause of the failure in S1004, S1006, or S1008 is a timeout of the timer.

When the cause of the failure is a timeout of the timer (YES in S1009), the flow shifts to S1001.

On the other hand, when the cause of the failure is not a timeout of the timer (NO in S1009), the flow shifts to S1010.

In S1010, delay processor 307 adds a BSSID of the failed AP to an STA blacklist because there may be another AP that can accept an Association exchange. Then, the flow shifts to S1011.

In S1011, delay processor 307 determines whether the same BSSID as the BSSID added in S1010 exists in the blacklist. In other words, in S1011, delay processor 307 determines whether the BSSID added in S1010 is a BSSID of the AP that has been added to the blacklist.

When the same BSSID as the BSSID added in S1010 has been already in the blacklist (YES in S1011), the flow shifts to S1012. When the same BSSID as the BSSID added in S1010 is not in the blacklist (NO in S1011), the flow shifts to S1001.

The case of YES in S1011 corresponds to a case where the BSSID added in S1010 was added to the blacklist a plurality of times. In this case, because connecting to another AP is difficult or has already been attempted, delay processor 307 adds a delay in S1012 so as not to continue scanning immediately. Further, a process of increasing a delay time may be added each time the number of times of adding the AP to the blacklist increases. Upon expiration of the waiting time, the flow shifts to S1001.

In S1013, delay processor 307 generates a waiting time for a scan interval in case that any AP is not detected in order to reduce power consumption or the like. Thus, the flow shifts to S1001 after waiting for the interval set until a re-scan is started.

Note that delay processor 307 may shorten the scan interval. Shortening the scan interval can speed up the shift to S1001.

Note that delay processor 307 may change a timeout value to be set to the timer for scan processor 301, considering that the number of search targets changes in accordance with the number of SSIDs registered in the blacklist.

Note that error processor 305 and error factor determiner 306 may change the timeout value to be set to the timer for each of join processor 302, association processor 303, and handshake processor 304, considering that the number of search targets is changed in accordance with the number of SSIDs registered in the blacklist.

As illustrated in FIG. 4, scan processor 301 (an example of “processing circuitry”) of the STA (an example of a “radio communication apparatus”) scans a connection destination candidate to be connected by radio (hereinafter, may be referred to as “radio connection destination candidate”). Then, when initial-connection processing (first initial-connection processing) to the connection destination candidate fails, error processor 305, error factor determiner 306, and delay processor 307 (examples of “control circuitry”) determine a start timing of second initial-connection processing based on a cause of the failure. Note that the cause of the failure may be, in addition to a timeout, a case where no response has been made after a packet for the connection processing is transmitted several times or a case where no beacon is received in a certain period in the case of millimeter-wave communication.

As described above, in the present embodiment, the STA executes the processing included in the initial-connection processing, and determines the start timing of the initial-connection processing (e.g., waiting time until starting the initial-connection processing) based on whether the executed processing fails due to a timeout of the timer. This configuration can avoid adding a delay time without adding the connection destination of the processing target into the blacklist, for example, when a timeout occurs because of a deterioration of a communication environment, so that the initial-connection time can be shortened (speeded up).

For example, in the STA, it is assumed that a process of adding a connection destination AP to the blacklist is executed to increase the efficiency of scan processing by excluding a connection destination AP that has some problem, such as a problem in that the external connection by the Internet is impossible, in that an intentional connection is undesirable because of a security-related concern such as a connection using a free Wi-Fi, or in that the communication speed is apparently slow compared to another AP when a plurality APs are present, from a target for the scan processing. In a mobility environment such as V2X communication, because continuous packet errors may occur, a delay of a penalty may be added to an AP that is connectable in a static environment where a packet error is less likely to occur.

According to the present embodiment, when a timeout occurs because of a deterioration of a communication environment or the like, adding the AP to the blacklist and adding a delay can be avoided; therefore, the initial-connection time can be shortened (speeded up). For example, connectability can be enhanced and the time in which data communication is possible can be secured even in a mobility environment, and thus data communication amount and frequency utilization efficiency can be enhanced. Further, when there is such a problem in that the connection is rejected by an AP due to password and/or encryption settings, the AP is added to the blacklist; therefore, the scan efficiency can be maintained.

Note that V2X communication has been described in the above-described embodiment, but the present disclosure is not limited to V2X communication. For example, the present disclosure may be applied to a communication environment different from V2X communication and an environment in which a packet error easily occur (e.g., an environment in which a large number of interruptions between an AP and an STA exist, or a communication near a cell edge or at a null point).

Further, the exemplary operation described in the above embodiment is merely an example, and may be changed as appropriate. Hereinafter, variations of the operation will be described.

### Variation 1

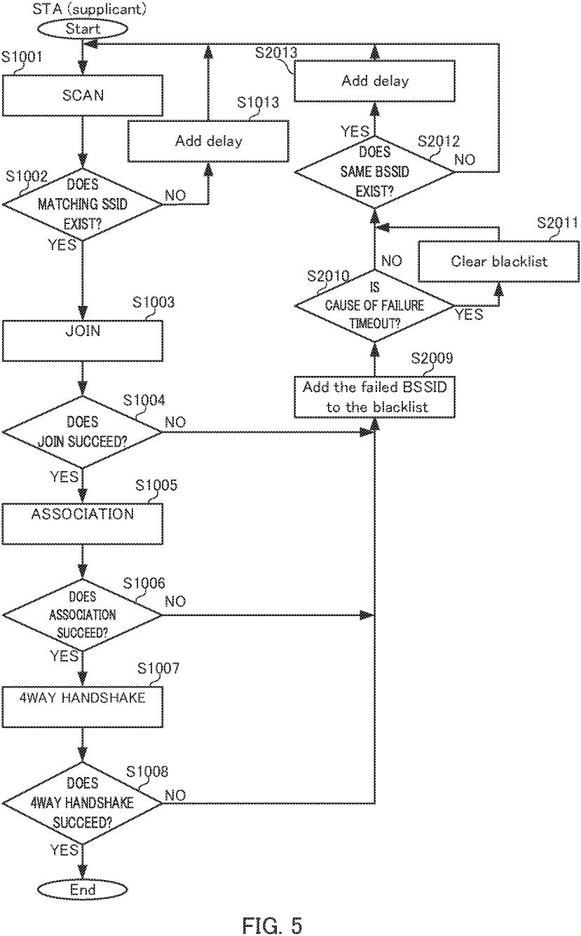

FIG. 5 is a flowchart illustrating an exemplary operation of onboard unit 1000 according to Variation 1 of the present embodiment. Note that, in FIG. 5, the same reference numerals are given to the same processes as in FIG. 4, and description thereof may be omitted.

In S2009, similarly to S1010, delay processor 307 adds a BSSID of the failed AP to an STA blacklist because there may be another AP that is capable of receiving an Association exchange. Adding the BSSID to the blacklist can exclude the AP from the target of a scan to be executed again; therefore, the re-scan can be speeded up.

In S2010, similarly to S1009, error factor determiner 306 determines whether the cause of the failure in S1004, S1006, or S1008 is a timeout of the timer.

When the cause of the failure is a timeout of the timer (YES in S2010), the flow shifts to S2011.

When the cause of the failure is not a timeout of the timer (NO in S2010), the flow shifts to S2012.

In S2011, delay processor 307 deletes the BSSID added to the blacklist in S2009 from the blacklist (Clear blacklist). Then, the flow shifts to S2012.

In S2012, delay processor 307 determines whether the same BSSID as the BSSID added in S2009 exists in the blacklist. In other words, delay processor 307 determines whether the BSSID added in S2009 is a BSSID of the AP that has ever been added to the blacklist.

When the same BSSID as the BSSID added in S2009 has been already in the blacklist (YES in S2012), the flow shifts to S2013. When the same BSSID as the BSSID added in S2009 is not in the blacklist (NO in S2012), the flow shifts to S1001. In S2013, similarly to S1012, delay processor 307 adds a delay so as not to continue scanning immediately.

As described above, in the example in FIG. 5, when the cause of the failure is a timeout of the timer (YES in S2010), the BSSID added in the blacklist in S2009 is deleted from the blacklist. Thus, when the cause of the failure is a timeout of the timer (YES in S2010), the BSSID added in S2009 is not a BSSID of the AP that has been added in the blacklist. In other words, the case where the cause of the failure is a timeout of the timer (YES in S2010) means no in S2012.

As described above, in Variation 1, when a timeout occurs because of a deterioration of a communication environment or the like, addition of a delay time can be avoided without adding the connection destination of the processing target; therefore, the initial-connection time can be shortened (speeded up).

### Variation 2

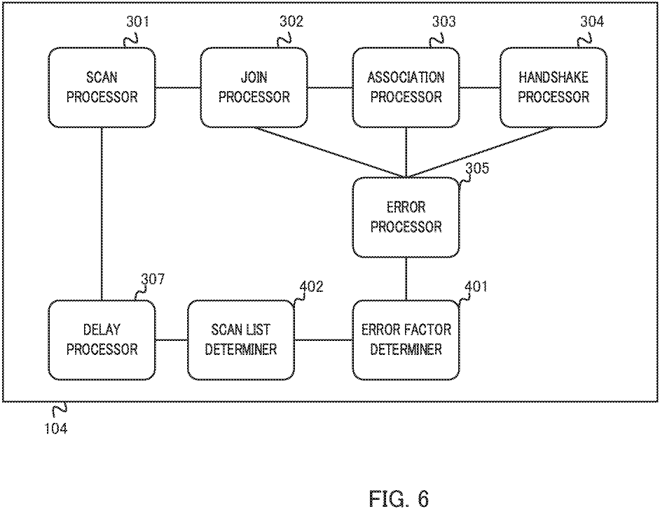

FIG. 6 illustrates an exemplary functional block in CPU 104 of onboard unit 1000 according to Variation 2 of the embodiment. Note that, in FIG. 6, the same components as in FIG. 3 are denoted by the same reference numerals, and description thereof may be omitted.

CPU 104 includes scan processor 301, join processor 302, association processor 303, handshake processor 304, error processor 305, error factor determiner 401, scan list determiner 402, and delay processor 307. A process of each component will be described along with an exemplary operation of onboard unit 1000 to be described below.

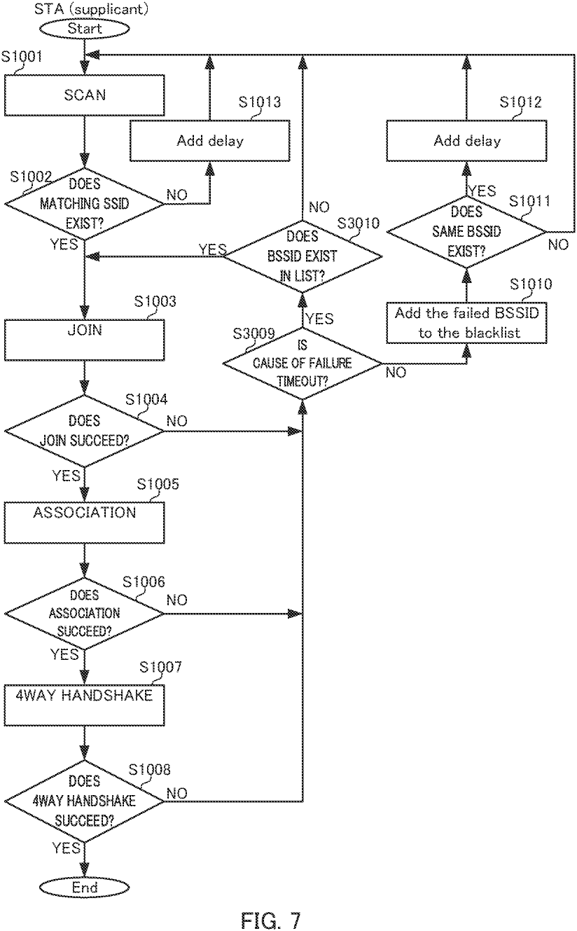

FIG. 7 is a flowchart illustrating an exemplary operation of onboard unit 1000 according to Variation 2 of the embodiment. Note that, in FIG. 7, the same reference numerals are given to the same processes as in FIG. 4, and description thereof may be omitted.

In S3009, error factor determiner 401 determines whether the cause of the failure in S1004, S1006, or S1008 is a timeout of the timer.

When the failure is due to a timeout of the timer (YES in S3009), the flow shifts to S3010.

On the other hand, when the cause of the failure is not a timeout of the timer (NO in S3009), the flow shifts to S1010.

In S3010, scan list determiner 402 determines whether a list of the scan result includes a BSSID corresponding to the AP to be connected (the candidate of the connection destination) in S1001.

When the list of the scan result includes the BSSID corresponding to the AP to be connected (YES in S3010), the flow shifts to S1003.

When the list of the scan result does not include the BSSID corresponding to the AP to be connected (NO in S3010), the flow shifts to S1001.

As described above, in the example in FIG. 7, when the list of the scan result includes the BSSID to be connected, the scan processing of S1001 (and S1002 and S1013) is skipped.

As described above, in Variation 2, when a timeout occurs because of a deterioration of a communication environment or the like, addition of a delay time can be avoided without adding the connection destination of the processing target; therefore, the initial-connection time can be shortened (speeded up). In addition, this configuration can omit the scan processing, and thereby can further shorten (speed up) the initial-connection time.

For example, while the list of the scan result in S1002 includes a desired BSSID, the scan processing (S1001 and S1002) can be skipped. Further, an exchange of a packet such as a Probe exchange can be reduced by a certain STA skipping scan processing, and thus the interference in the packet exchange of an STA existing around the STA can be reduced, which result in enhancing the scan efficiency of an STA existing around the STA.

Note that in the above-described embodiment, the example has been described in which communication is performed using an infrastructure mode in accordance with IEEE 802.11ad and/or IEEE 802.11ay, which are 60 GHz millimeter-wave communication standards, but the present disclosure is not limited thereto. The present disclosure may be applied to a communication standard different from the above-described communication standards, or may be applied to a communication using a mode different from the infrastructure mode (e.g., an ad hoc mode).

In addition, the term representing each signal (each packet) in the above-described embodiment is merely an example, and the present disclosure is not limited thereto. For example, a packet may be replaced with a slot, a time slot, a mini-slot, a frame, a subframe, or the like.

In the above-described embodiments, the term “-er/-or” or “unit” used for the name of the component may be replaced with another term such as “circuitry”, “assembly”, “device”, or “module”.

The present disclosure can be realized by software, hardware, or software in cooperation with hardware. Each functional block used in the description of each embodiment described above can be partly or entirely realized by an LSI such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

The technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A radio communication apparatus according to an embodiment of the present disclosure includes: processing circuitry, which, in operation, scans a radio connection destination candidate; and control circuitry, which, in operation, determines, when first initial-connection processing to the connection destination target fails, a start timing of second-initial connection processing based on a cause of the failure, wherein the processing circuitry scans the connection destination candidate based on the start timing of the second initial-connection processing.

In the radio communication apparatus according to the embodiment of the present disclosure, the cause is a timeout of first processing included in the first initial-connection processing, and the control circuitry determines the start timing based on whether the first processing fails due to a timeout.

In the radio communication apparatus according to the embodiment of the present disclosure, when the first processing fails due to a timeout, the control circuitry does not increase a waiting time for the start timing of the second initial-connection processing.

In the radio communication apparatus according to the embodiment of the present disclosure, when the first processing fails due to a timeout, the control circuitry determines whether to skip scan processing in the second initial-connection processing, based on a list of a connection destination of the radio communication apparatus.

In the radio communication apparatus according to the embodiment of the present disclosure, when the first processing does not fail due to a timeout, the control circuitry determines the start timing based on a list of a connection destination to be excluded from a processing target of the initial-connection processing.

In the radio communication apparatus according to the embodiment of the present disclosure, when the first processing fails due to a timeout, the control circuitry deletes a connection destination of a processing target of the first initial-connection processing from a list of a connection destination to be excluded from the processing target of the first initial-connection processing.

In the radio communication apparatus according to the embodiment of the present disclosure, when the first processing fails due to a timeout, the control circuitry does not add a connection destination of a processing target of the first initial-connection processing to a list of a connection destination to be excluded from the processing target of the first initial-connection processing.

In the radio communication apparatus according to the embodiment of the present disclosure, the first processing is at least one of synchronization processing between the radio communication apparatus and a communication counterpart of the radio communication apparatus, association processing between the radio communication apparatus and the communication partner of the radio communication apparatus, and/or key generation processing for performing encrypted data communication.

In the radio communication apparatus according to the embodiment of the present disclosure, the control circuitry shortens a period of scan processing included in the initial-connection processing.

In the radio communication apparatus according to the embodiment of the present disclosure, the control circuitry changes a timeout value of the first processing.

A radio communication method according to the embodiment of the present disclosure includes: scanning, by a radio communication apparatus, a radio connection destination candidate, determining, by the radio communication apparatus, when first initial-connection processing to the connection destination candidate fails, a start timing of second initial-connection processing based on a cause of the failure, and scanning, by the radio communication apparatus, the connection destination candidate based on the start timing of the second initial-connection processing.

### Industrial Applicability

An embodiment of the present disclosure is useful in a mobile communication system.

### Reference Signs List

| | |
|---|---|
| 101, 201 | Communication apparatus |
| 102, 202 | Interface (IF) circuitry |
| 103, 203 | Memory |
| 104, 204 | Central processing unit (CPU) |
| 301 | Scan processor |
| 302 | Join processor |
| 303 | Association processor |
| 304 | Handshake processor |
| 305 | Error processor |
| 306, 401 | Error factor determiner |
| 307 | Delay processor |
| 402 | Scan list determiner |
| 1000 | Onboard unit |
| 2000 | Roadside unit |

1. A radio communication apparatus comprising:
processing circuitry, which, in operation, scans a radio connection destination candidate; and
control circuitry, which, in operation, determines, when first initial-connection processing to the radio connection destination target fails, a start timing of second-initial connection processing based on a cause of the failure, wherein
the processing circuitry scans the connection destination candidate based on the start timing of the second initial-connection processing.

2. The radio communication apparatus according to claim 1, wherein
the cause is a timeout of first processing included in the first initial-connection processing, and
the control circuitry determines the start timing based on whether the first processing fails due to a timeout.

3. The radio communication apparatus according to claim 2, wherein
when the first processing fails due to a timeout, the control circuitry does not increase a waiting time for the start timing of the second initial-connection processing.

4. The radio communication apparatus according to claim 2, wherein
when the first processing fails due to a timeout, the control circuitry determines whether to skip scan processing in the second initial-connection processing, based on a list of a connection destination of the radio communication apparatus.

5. The radio communication apparatus according to claim 2, wherein
when the first processing does not fail due to a timeout, the control circuitry determines the start timing based on a list of a connection destination to be excluded from a processing target of the initial-connection processing.

6. The radio communication apparatus according to claim 2, wherein
when the first processing fails due to a timeout, the control circuitry deletes a connection destination of a processing target of the first initial-connection processing from a list of a connection destination to be excluded from the processing target of the first initial-connection processing.

7. The radio communication apparatus according to claim 2, wherein
when the first processing fails due to a timeout, the control circuitry does not add a connection destination of a processing target of the first initial-connection processing to a list of a connection destination to be excluded from the processing target of the first initial-connection processing.

8. The radio communication apparatus according to claim 2, wherein
the first processing is at least one of synchronization processing between the radio communication apparatus and a communication counterpart of the radio communication apparatus, association processing between the radio communication apparatus and the communication partner of the radio communication apparatus, and/or key generation processing for performing encrypted data communication.

9. The radio communication apparatus according to claim 1, wherein
the control circuitry shortens a period of scan processing included in the initial-connection processing.

10. The radio communication apparatus according to claim 4, wherein
the control circuitry changes a timeout value of the first processing.

11. A radio communication method comprising:
scanning, by a radio communication apparatus, a radio connection destination candidate,
determining, by the radio communication apparatus, when first initial-connection processing to the connection destination candidate fails, a start timing of second initial-connection processing based on a cause of the failure, and
scanning, by the radio communication apparatus, the connection destination candidate based on the start timing of the second initial-connection processing.
